(19) United States
(12) Patent Application Publication
(10) Pub. No.: US 2026/0201144 A1
(43) Pub. Date: Jul. 16, 2026

(54) Formulation for preservation and protection of exterior surfaces of real estate properties

(71) Applicants: Richard Winget, JR., Doylestown, PA (US); Richard O Winget, SR., Warwick, PA (US)

(72) Inventors: Richard Winget, JR., Doylestown, PA (US); Richard O Winget, SR., Warwick, PA (US)

(21) Appl. No.: 18/831,874

(22) Filed: Oct. 20, 2025

Related U.S. Application Data
(63) Continuation-in-part of application No. 18/831,076, filed on Jun. 12, 2024.

(51) Int. Cl. C08K 5/00; C08K 5/06; C08K 5/101; C08K 5/3415; C08K 5/3475; C08K 5/5419; C09D 175/04

(52) U.S. Cl. CPC C08K 5/005; C08K 5/06; C08K 5/101; C08K 5/3415; C08K 5/3475; C08K 5/5419; C09D 175/04

(57) ABSTRACT

This invention relates to a formulation comprising alternative ingredients and designed to be applied to the exterior of commercial, residential and real estate properties such as roofs, siding and other external surfaces and functions as rejuvenating and protecting agents.

### RELATED APPLICATIONS

This application is a continuation-in-part and claims priority to the U.S. patent application Ser. No. 18/831,076 filed on Jun. 12, 2024 entitled “Formulation For Rejuvenation and Protection of Exterior Surfaces of Real Estate Properties”.

### BACKGROUND OF THE INVENTION

Asphalt shingles fail because of UV degradation, water infiltration, and thermal degradation. Prolonged exposure to weather conditions such as heat from the sun, torrential rain, heavy snow, ice and hail as well as impact damage from storms and flying debris can cause damage to asphalt shingles. One or more of these conditions can affect the asphalt to molting ratio and when that occurs, the shingles become more brittle and the granules do not adhere so it has granule loss or aggregate loss. Once you've gotten to a point of significant granule loss and the asphalt becomes extremely brittle, water can easily penetrate into your roof and eventually your home, causing mold problems and property damage. There are various prior art formulations that try to address this homeowner nightmare. However, these formulations employ chemistries in the roof rejuvenation market that simply address one or two of the failure mechanisms.

The presently claimed invention contains chemistry that addresses that imbalance in the asphaltene to maltene ratio. It also contains chemistries that grab onto the individual aggregate or granules and lock them into the surface to prevent future degradation of the granules and granular loss. Furthermore, the present invention contains automotive grade UV inhibitors and blockers and as most people know the paint on a car lasts a really, really long time. Thus, this invention uses similar types of UV block degradation and a similar type of chemistry to help protect anything that is underneath the formulation, primarily the asphalt shingles themselves. The formulation of this invention has the capability of penetrating any microcraze or small microscopic cracks developed as a result of the above-mentioned causational effects of deteriorating asphalt shingles. This formulation, once applied, will penetrate and fill in those cracks which can help reduce water degradation and water damage to the roof. The automotive grade UV inhibitors and blockers synergistically work together.

As the UV energy comes down and tries to attack the shingles, the UV blockers of this formulation both block the UV rays from attacking the polymers and it also dissipates that energy so that the polymers which are the functional vehicles of the formulation are not able to be damaged by UV energy. The formulation of the present invention has a built-in 300+ percent elongation which means how long and far that film can stretch before breaking and causing problems as over 300% elongation. What that means is your asphalt shingles can expand and contract well within that 300%. The present invention is formulated to address every single failure mechanism of asphalt shingle roof and then go one step above and address every future potential failure mechanism of the formulation itself. In other words, the asphalt shingles are brought back to a nearly new condition and the rejuvenation allows for not just those restorative chemistries but it contains significant protection chemistries at the same time. The future issues are protected and the existing weathering in the asphalt shingles are reversed.

### SUMMARY OF THE INVENTION

In one embodiment, the formulation comprises active agents, said active agents consisting of at least one surface binding agent selected from the group consisting of acrylic methacrylate, poly methyl methacrylate, and mixture and combinations thereof, at least one strength and elongation enhancer which is a polyurethane dispersion, at least one cosolvent selected which is N-methyl pyrrolidone, at least one corrosion inhibitor and surface active agent which is triethanolamine, at least one defoamer selected from the group consisting of petroleum distillates, petroleum distillate silicone, petroleum distillate oil, and mixture and combinations thereof, at least one dynamic surface energy reducer which is ethoxylated acetylenic surfactant, at least one water repellant selected from the group consisting of amorphous synthetic silica, silicone dioxide, and mixtures and combinations thereof, at least one adhesion promoter which is glycidoxypropyltrimethoxysilane, at least one UV absorber and light stabilizer which is hydrophilic 2-(2-hydroxyphenyl)-benzotriazole, at least one antifungal agent selected from the group consisting of 3-(3,4-dichlorophenyl)-1,1-dimethylurea, methyl 2-benzimidazolecarbamate, 3-Iodo-2-propynyl butyl carbamate, and mixtures and combinations thereof, at least one solvent which is diethylene glycol monobutyl ether, and at least one rheology modifier which is polyether polyurethane.

In another embodiment, the formulation is designed to be applied to surfaces of commercial, residential and real estate properties such as roofs, siding and all exterior surfaces to function as rejuvenating and protecting agents.

In yet another embodiment, the formulation further comprises water. In still another embodiment, the polyurethane dispersion plays a significant role in allowing the formulation to adapt to the thermal expansion and contraction of building product surfaces. In still yet another embodiment, the N-methyl pyrrolidone functions as a color restoring surface penetrant. In a further embodiment, the triethanolamine functions to increase temperature range for application. In another further embodiment, the ethoxylated acetylenic surfactant and N-methyl pyrrolidone play a significant role in microcrazing remediation.

In yet a further embodiment, the glycidoxypropyltrimethoxysilane is a glycidol reactive organic group and a trimethoxysilyl inorganic group that reacts organic compounds on one end and inorganic compounds on the other end of the molecule.

In still a further embodiment, the diethylene glycol monobutyl ether functions as a high boiling point solvent allowing the solvency of the polyether polyurethane and allows acrylic and polyurethane polymer particles to coalesce and form a film.

In still yet a further embodiment, the polyester polyurethane functions by providing elastic characteristics for the coating which allows for both penetration and a uniform surface, providing body to said formulation resisting runs and drips during application, providing pseudoplastic flow characteristics allowing it to be sprayed and applied under high shear application methods.

In another embodiment, the at least one surface binding agent is from about 4 to about 40% by weight of the formulation.

In a further embodiment, the at least one strength and elongation enhancer is from about 1 to about 70% by weight of the formulation.

In another further embodiment, the at least one cosolvent is from about 0.01 to about 25% by weight of the formulation.

In still another further embodiment, the corrosion inhibitor and surface active agent is from about 0.01 to about 5% by weight of the formulation.

In yet another further embodiment, the at least one defoamer is from about 0.5 to about 4% by weight of the formulation.

In still yet another further embodiment, the at least one dynamic surface energy reducer is from about 0.1 to about 5% by weight of the formulation.

In another embodiment, the at least one water repellant is from about 0.1 to about 10% by weight of the formulation.

In a further embodiment, the at least one adhesion promoter is from about 0.1 to about 10% by weight of the formulation.

In still another embodiment, the at least one UV absorber and light stabilizer is from about 0.1 to about 15% by weight of the formulation.

In yet another embodiment, the at least one antifungal agent is from about 0.1 to about 30% by weight of the formulation.

In still yet another embodiment, the at least one solvent is from about 2 to about 14% by weight of the formulation.

In a further embodiment, the at least one rheology modifier is from about 2 to about 18% by weight of the formulation.

In another further embodiment, the water is from about 10 to about 95% by weight of the formulation.

In another further embodiment, the present invention relates to a formulation for roof and siding rejuvenation comprising active agents, and the active agents consisting of water, at least one surface binding agent selected from the group consisting of acrylic methacrylate, poly methyl methacrylate, and mixture and combinations thereof, at least one strength and elongation enhancer which is a polyurethane dispersion, at least one cosolvent selected which is N-methyl pyrrolidone, at least one corrosion inhibitor and surface active agent which is triethanolamine, at least one defoamer selected from the group consisting of petroleum distillates, petroleum distillate silicone, petroleum distillate oil, and mixture and combinations thereof, at least one dynamic surface energy reducer which is ethoxylated acetylenic surfactant, at least one water repellant selected from the group consisting of amorphous synthetic silica, silicone dioxide, and mixtures and combinations thereof, at least one adhesion promoter which is glycidoxypropyltrimethoxysilane, at least one UV absorber and light stabilizer which is hydrophilic 2-(2-hydroxyphenyl)-benzotriazole, at least one antifungal agent selected from the group consisting of 3-(3,4-dichlorophenyl)-1,1-dimethylurea, methyl 2-benzimidazolecarbamate, 3-Iodo-2-propynyl butyl carbamate, and mixtures and combinations thereof, at least one solvent which is diethylene glycol monobutyl ether, and at least one rheology modifier which is polyether polyurethane.

In still another further embodiment, the water functions to increase open time which allows the ingredients to better eliminate microcrazing, allow ingredients to form a more perfect film, and to assist in cost efficiency in the manufacturing of the formulation.

In another embodiment, the present invention relates to a formulation comprising of:
at least one surface binding agent selected from the group consisting of acrylic methacrylate, poly methyl methacrylate, styrene, styrene acrylic, styrene butadiene, vinyl acetate, vinyl acrylic, silicone, polysiloxane, silicone acrylates, polyether silicone copolymer, trimethylsiloxysilicate, silicone resin, aromatic polyurethane, polyurea, epoxy, nitrocellulose, polyvinyl butyral, cellulose acetate butyrate, chlorinated rubber, styrene butadiene styrene, epoxy polyester hybrid, urethane acrylic hybrid, urethane acrylics synthesized polymer, UV/EB Curable polymer, fluoropolymer, polyvinylidene fluoride, melamine formaldehyde, urea formaldehyde, alkyds, unsaturated polyesters, phenolic resins, polyureas, inorganic binders, silicates, drying oils, and mixture and combinations thereof;
at least one strength and elongation enhancer selected from the group consisting of polyurethane, polyvinylidene fluoride, aromatic polyurethane, melamine formaldehyde, polyurea, silicates, polyesters, styrene butadiene styrene, epoxy, nitrocellulose, styrene acrylic, vinyl acrylate, and mixture and combinations thereof;
at least one cosolvent selected from the group consisting of N-methyl pyrrolidone, propylene glycol, dipropylene glycol methyl ether, tripropylene glycol methyl ether, diethylene glycol monobutyl ether, ethyl lactate, soy methyl ester, palm oil and its derivatives, dimethyl sulfone, butyl levulinate esters, butyl levulinic esters, isobutanol, methyl soyate, 1-methylimidazole, hydrocarbon solvents, triethanolamine, methanol, benzene, acetone, ethanol, bio-based solvents, and mixtures and combinations thereof;
at least one corrosion inhibitor and surface active agent selected from the group consisting of triethanolamine, phosphate based inhibitors (zinc phosphate, calcium phosphate, strontium phosphate, etc), molybdate inhibitors such as sodium molybdate, orate based inhibitors, silicate based inhibitors such as colloidal silica, fumed silica, sodium metasilicate, organic corrosion inhibitors such as tannic acid, benzotriazole, toly triazole, 2-Mercaptobenzothiazole (MBT), amine based corrosion inhibitors such as monoethanolamine borate, diisopropanolamine derivatives, rare earth metal corrosion inhibitors such as Cerium Oxide or Cerium Nitrate, sodium benzoate, plant based corrosion inhibitors, polymeric inhibitors designed to block corrosion pathways such as polymers with functional sites or that chelate, and mixtures and combinations thereof;
at least one defoamer selected from the group consisting of petroleum distillates, petroleum distillate silicone, petroleum distillate oil, mineral oils, silicone based defoamers, polydimethylsiloxane, modified silicones, mineral oil free defoamers, fatty alcohols, esters, polymeric defoamers, polyacrylates, polyethers, siloxane copolymers, emulsion defoamers, powdered defoamers, surfactant blends, and mixture and combinations thereof;
at least one dynamic surface energy reducer selected from the group consisting of ethoxylated acetylene, silicone based modifiers such as polyether modified silicone, amino functional silicone, polydimethylsiloxanes, fluoro surfactants, fluoropolymers, polyacrylate, polyurethane surface energy modifiers, wax based surface energy modifiers, carnauba, polyethylene, polytetrafluoroethylene dispersions, silane based surface energy modifiers, nano particles hydrophobic silica, alumina, titania treated with alkyl or fluorinated compounds, and mixture and combinations thereof;
at least one water repellent selected from the group consisting of amorphous synthetic silica, silicone dioxide, wax based water repellents, fluorosurfactants and fluoropolymers, polyvinylidene fluoride, silicone based additives, siloxane emulsions, polyether modified silicone, amino functional silicone, fluoropolymers, waxes, silane, siloxane, nano particle sized additives, hydrophobically modified silica and alumina, film forming binders, hydrophobic acrylics, urethane-acrylic hybrids, silicone-acrylate copolymers, urethanes, and mixtures and combinations thereof;
at least one adhesion promoter selected from the group consisting of glycidoxypropyltrimethoxysilane, organofunctional silanes, epoxy silanes, amino silanes, methacryloxy silanes, phosphate-based adhesion promoters, zirconium phosphate, polyphosphates, anionic surfactants, cationic surfactants, functional polymers, chloropolyolefins, epoxy dispersions, polyurethane dispersions, hydroxyl polyurethane dispersions, carboxyl-modified polyurethane dispersions, maleic anhydride additives, and mixtures and combinations thereof;
at least one UV absorber and light stabilizer selected from the group consisting of hydrophilic 2-(2-hydroxyphenyl)-benzotriazole, triazines, benzotriazoles, benzophenones, hindered amine light stabilizers, titanium dioxide, zinc oxide, hybrid chemistries, photo stabilized acrylic and polyurethane polymers, fumed, amorphous, uniform or surface modified silicas, and mixtures and combinations thereof;
at least one antifungal agent selected from the group consisting of 3-(3,4-dichlorophenyl)-1,1-dimethylurea, methyl 2-benzimidazolecarbamate, 3-Iodo-2-propynyl butyl carbamate, zinc based chemistries, zinc omadine, zinc 2-pyridinethiol-N-oxide, zinc pyrithione, iodopropynyl butylcarbamate, carbamates, isothiazolinones, azole-based fungicides, organotin, quaternary ammonium compounds, metals, and mixtures and combinations thereof;
at least one solvent selected from the group consisting of diethylene glycol monobutyl ether, water, glycol ethers, alcohols, diols, polyols, esters, lactates, VOC exempt solvents, low VOC solvents, t-butyl acetate, acetone, dimethyl carbonate, methyl acetate, dibasic esters, γ-Butyrolactone, and mixtures and combinations thereof; and
at least one rheology modifier selected from the group consisting of polyether polyurethane, cellulose ethers, hydroxyethyl cellulose, hydroxypropyl methylcellulose, alkali swellable emulsions, hydrophobically modified alkali swellable emulsions, hydrophobically modified ethylene oxide urethanes, polyurethane thickeners, inorganic rheology modifiers, and mixtures and combinations thereof.

In a further embodiment, the present invention provides for a formulation comprising active agents, said active agents comprises of:
at least one liquid;
at least one surface binding agent selected from the group consisting of acrylic methacrylate, poly methyl methacrylate, styrene, styrene acrylic, styrene butadiene, vinyl acetate, vinyl acrylic, silicone, polysiloxane, silicone acrylates, polyether silicone copolymer, trimethylsiloxysilicate, silicone resin, aromatic polyurethane, polyurea, epoxy, nitrocellulose, polyvinyl butyral, cellulose acetate butyrate, chlorinated rubber, styrene butadiene styrene, epoxy polyester hybrid, urethane acrylic hybrid, urethane acrylics synthesized polymer, UV/EB Curable polymer, fluoropolymer, polyvinylidene fluoride, melamine formaldehyde, urea formaldehyde, alkyds, unsaturated polyesters, phenolic resins, polyureas, inorganic binders, silicates, drying oils, and mixture and combinations thereof;
at least one strength and elongation enhancer selected from the group consisting of polyurethane, polyvinylidene fluoride, aromatic polyurethane, melamine formaldehyde, polyurea, silicates, polyesters, styrene butadiene styrene, epoxy, nitrocellulose, styrene acrylic, vinyl acrylate, and mixture and combinations thereof;
at least one cosolvent selected from the group consisting of N-methyl pyrrolidone, propylene glycol, dipropylene glycol methyl ether, tripropylene glycol methyl ether, diethylene glycol monobutyl ether, ethyl lactate, soy methyl ester, palm oil and its derivatives, dimethyl sulfone, butyl levulinate esters, butyl levulinic esters, isobutanol, methyl soyate, 1-methylimidazole, hydrocarbon solvents, triethanolamine, methanol, benzene, acetone, ethanol, bio-based solvents, and mixtures and combinations thereof;
at least one defoamer selected from the group consisting of petroleum distillates, petroleum distillate silicone, petroleum distillate oil, mineral oils, silicone based defoamers, polydimethylsiloxane, modified silicones, mineral oil free defoamers, fatty alcohols, esters, polymeric defoamers, polyacrylates, polyethers, siloxane copolymers, emulsion defoamers, powdered defoamers, surfactant blends, and mixture and combinations thereof;
at least one UV absorber and light stabilizer selected from the group consisting of hydrophilic 2-(2-hydroxyphenyl)-benzotriazole, triazines, benzotriazoles, benzophenones, hindered amine light stabilizers, titanium dioxide, zinc oxide, hybrid chemistries, photo stabilized acrylic and polyurethane polymers, fumed, amorphous, uniform or surface modified silicas, and mixtures and combinations thereof;
at least one solvent selected from the group consisting of diethylene glycol monobutyl ether, water, glycol ethers, alcohols, diols, polyols, esters, lactates, VOC exempt solvents, low VOC solvents, t-butyl acetate, acetone, dimethyl carbonate, methyl acetate, dibasic esters, γ-Butyrolactone, and mixtures and combinations thereof; and
at least one rheology modifier selected from the group consisting of polyether polyurethane, cellulose ethers, hydroxyethyl cellulose, hydroxypropyl methylcellulose, alkali swellable emulsions, hydrophobically modified alkali swellable emulsions, hydrophobically modified ethylene oxide urethanes, polyurethane thickeners, inorganic rheology modifiers, and mixtures and combinations thereof.

In another further embodiment, the present invention relates to a formulation comprising active agents, said active agents comprises of:
at least one liquid is selected from the group consisting of distilled water, bottled water, tap water, mineral water, purified water, alkaline water, spring water, well water, drinking water, and mixtures and combinations thereof;
at least one liquid is selected from the group consisting of distilled water, bottled water, tap water, mineral water, purified water, alkaline water, spring water, well water, drinking water, and mixtures and combinations thereof
at least one surface binding agent selected from the group consisting of acrylic methacrylate, poly methyl methacrylate, styrene, styrene acrylic, styrene butadiene, vinyl acetate, vinyl acrylic, silicone, polysiloxane, silicone acrylates, polyether silicone copolymer, trimethylsiloxysilicate, silicone resin, aromatic polyurethane, polyurea, epoxy, nitrocellulose, polyvinyl butyral, cellulose acetate butyrate, chlorinated rubber, styrene butadiene styrene, epoxy polyester hybrid, urethane acrylic hybrid, urethane acrylics synthesized polymer, UV/EB Curable polymer, fluoropolymer, polyvinylidene fluoride, melamine formaldehyde, urea formaldehyde, alkyds, unsaturated polyesters, phenolic resins, polyureas, inorganic binders, silicates, drying oils, and mixture and combinations thereof;
at least one strength and elongation enhancer selected from the group consisting of polyurethane, polyvinylidene fluoride, aromatic polyurethane, melamine formaldehyde, polyurea, silicates, polyesters, styrene butadiene styrene, epoxy, nitrocellulose, styrene acrylic, vinyl acrylate, and mixture and combinations thereof;
at least one cosolvent selected from the group consisting of N-methyl pyrrolidone, propylene glycol, dipropylene glycol methyl ether, tripropylene glycol methyl ether, diethylene glycol monobutyl ether, ethyl lactate, soy methyl ester, palm oil and its derivatives, dimethyl sulfone, butyl levulinate esters, butyl levulinic esters, isobutanol, methyl soyate, 1-methylimidazole, hydrocarbon solvents, triethanolamine, methanol, benzene, acetone, ethanol, bio-based solvents, and mixtures and combinations thereof;
at least one corrosion inhibitor and surface active agent selected from the group consisting of triethanolamine, phosphate based inhibitors (zinc phosphate, calcium phosphate, strontium phosphate, etc), molybdate inhibitors such as sodium molybdate, orate based inhibitors, silicate based inhibitors such as colloidal silica, fumed silica, sodium metasilicate, organic corrosion inhibitors such as tannic acid, benzotriazole, toly triazole, 2-Mercaptobenzothiazole (MBT), amine based corrosion inhibitors such as monoethanolamine borate, diisopropanolamine derivatives, rare earth metal corrosion inhibitors such as Cerium Oxide or Cerium Nitrate, sodium benzoate, plant based corrosion inhibitors, polymeric inhibitors designed to block corrosion pathways such as polymers with functional sites or that chelate, and mixtures and combinations thereof;
at least one defoamer selected from the group consisting of petroleum distillates, petroleum distillate silicone, petroleum distillate oil, mineral oils, silicone based defoamers, polydimethylsiloxane, modified silicones, mineral oil free defoamers, fatty alcohols, esters, polymeric defoamers, polyacrylates, polyethers, siloxane copolymers, emulsion defoamers, powdered defoamers, surfactant blends, and mixture and combinations thereof;
at least one dynamic surface energy reducer selected from the group consisting of ethoxylated acetylene, silicone based modifiers such as polyether modified silicone, amino functional silicone, polydimethylsiloxanes, fluoro surfactants, fluoropolymers, polyacrylate, polyurethane surface energy modifiers, wax based surface energy modifiers, carnauba, polyethylene, polytetrafluoroethylene dispersions, silane based surface energy modifiers, nano particles hydrophobic silica, alumina, titania treated with alkyl or fluorinated compounds, and mixture and combinations thereof;
at least one water repellent selected from the group consisting of amorphous synthetic silica, silicone dioxide, wax based water repellents, fluorosurfactants and fluoropolymers, polyvinylidene fluoride, silicone based additives, siloxane emulsions, polyether modified silicone, amino functional silicone, fluoropolymers, waxes, silane, siloxane, nano particle sized additives, hydrophobically modified silica and alumina, film forming binders, hydrophobic acrylics, urethane-acrylic hybrids, silicone-acrylate copolymers, urethanes, and mixtures and combinations thereof;
at least one adhesion promoter selected from the group consisting of glycidoxypropyltrimethoxysilane, organofunctional silanes, epoxy silanes, amino silanes, methacryloxy silanes, phosphate-based adhesion promoters, zirconium phosphate, polyphosphates, anionic surfactants, cationic surfactants, functional polymers, chloropolyolefins, epoxy dispersions, polyurethane dispersions, hydroxyl polyurethane dispersions, carboxyl-modified polyurethane dispersions, maleic anhydride additives, and mixtures and combinations thereof;
at least one UV absorber and light stabilizer selected from the group consisting of hydrophilic 2-(2-hydroxyphenyl)-benzotriazole, triazines, benzotriazoles, benzophenones, hindered amine light stabilizers, titanium dioxide, zinc oxide, hybrid chemistries, photo stabilized acrylic and polyurethane polymers, fumed, amorphous, uniform or surface modified silicas, and mixtures and combinations thereof;
at least one antifungal agent selected from the group consisting of 3-(3,4-dichlorophenyl)-1,1-dimethylurea, methyl 2-benzimidazolecarbamate, 3-Iodo-2-propynyl butyl carbamate, zinc based chemistries, zinc omadine, zinc 2-pyridinethiol-N-oxide, zinc pyrithione, iodopropynyl butylcarbamate, carbamates, isothiazolinones, azole-based fungicides, organotin, quaternary ammonium compounds, metals, and mixtures and combinations thereof;
at least one solvent selected from the group consisting of diethylene glycol monobutyl ether, water, glycol ethers, alcohols, diols, polyols, esters, lactates, VOC exempt solvents, low VOC solvents, t-butyl acetate, acetone, dimethyl carbonate, methyl acetate, dibasic esters, γ-Butyrolactone, and mixtures and combinations thereof; and
at least one rheology modifier selected from the group consisting of polyether polyurethane, cellulose ethers, hydroxyethyl cellulose, hydroxypropyl methylcellulose, alkali swellable emulsions, hydrophobically modified alkali swellable emulsions, hydrophobically modified ethylene oxide urethanes, polyurethane thickeners, inorganic rheology modifiers, and mixtures and combinations thereof.

### DETAILED DESCRIPTION OF THE INVENTION

As required, detailed embodiments of the present invention are disclosed herein; however, it is to be understood that the disclosed embodiments are merely exemplary of the invention that may be embodied in various forms. The figures are not necessarily to scale, some features may be exaggerated to show details of particular components. Therefore, specific structural and functional details disclosed herein are not to be interpreted as limiting, but merely as a basis for the claims and as a representative basis for teaching one skilled in the art to variously employ the present invention.

The present invention provides a formulation that functions as a rejuvenating and protecting agent that is designed to be applied to surfaces of commercial, residential and real estate properties such as roofs, siding and all exterior surfaces.

### Poly Methyl Methacrylate

Poly methyl methacrylate (PMMA) consists of various primers, base resins and wearing layers that are catalyzed to create an extremely durable and long lasting waterproofing system. PMMA is a synthetic polymer that can be applied to a seamless, fully bonded membrane that fills cracks and gaps. PMMA has numerous benefits, including:
Weather resistance (withstand freezing temperatures, heat waves, heavy rainfall, snow and hail
UV resistance (resistant to UV rays from the sun)
Alkali resistance
Long life expectancy

### Polyurethane Dispersion

Recognized for their excellent strength and durability, polyurethane roof coatings are ideal for a wide range of commercial and industrial surfaces. Sometimes referred to as polyurethane roof paint, they form a protective coating over foam roof coatings as well as other commercial roof substrates, including modified bitumen, smooth BUR, concrete, and masonry. Polyurethane roof coatings are also an outstanding choice for the lining and sealing of interior gutter systems. For purposes of this invention, polyurethane dispersion also plays a significant role in allowing the formulation to adapt to the thermal expansion and contraction of building product surfaces.

Part of what makes polyurethane roof coatings stand out is their flexibility, which helps them stand up well to even the harshest weather conditions. From extreme cold to extreme heat, polyurethane roof coatings withstand the daily thermal expansion and contraction of roof structures to deliver long-lasting performance. There are two types of polyurethane roof coatings: aliphatic and aromatic. Aliphatic polyurethane roof coatings are typically used as a top coat. They hold their color for a long time, resist dirt, and are UV stable. Aromatic polyurethane roof coatings are more often used as a base coat.

### N-Methyl Pyrrolidone

N-Methylpyrrolidone (NMP) is a solvent used in a variety of industries and applications, such as paint and coating removal, petrochemical processing, engineering plastics coatings, agricultural chemicals, electronic cleaning and industrial/domestic cleaning. NMP is an organic compound consisting of a 5-membered lactam. It is a colorless liquid, although impure samples can appear yellow. It is miscible with water and with most common organic solvents. It also belongs to the class of dipolar aprotic solvents such as dimethylformamide and dimethyl sulfoxide. It is used in the petrochemical, polymer and battery industries as a solvent, exploiting its non-volatility and ability to dissolve diverse materials (including polyvinylidene difluoride, PVDF). For purposes of this invention, N-methyl pyrrolidone also functions as a color restoring surface penetrant.

### Triethanolamine

Triethanolamine, or TEOA, is an organic compound with the chemical formula N(CH2CH2OH)3. It is a colorless, viscous liquid. It is both a tertiary amine and a triol. A triol is a molecule with three alcohol groups. Triethanolamine is used primarily in making surfactants, such as for emulsifiers. It is a common ingredient in formulations used for both industrial and consumer products. The triethanolamine neutralizes fatty acids, adjusts and buffers the pH, and solubilizes oils and other ingredients that are not completely soluble in water. For purposes of this invention, triethanolamine also functions to increase temperature range for application.

### Petroleum Distillates

Petroleum distillates are a group of hydrocarbon-based chemicals that are refined from crude oil and they refer to any mixture of volatile organic compounds produced by a refining process, including, but not limited to, naphtha, gasoline, kerosene, diesel oil, domestic fuel oil and petroleum products. For purposes of this invention, the petroleum distillates also function as anti-foaming agents, allowing a near perfect film creation.

### Ethoxylated Acetylenic Surfactant

Ethoxylated Acetylenic Diol (EAD) is a nonionic surfactant with the following properties:
Low-foam dynamic surface tension reduction
specifically for water-based systems
improves wetting of various substrates and pigments
Wets and prevents smut formation in metalworking fluids
APEO free, zero VOC, non-toxic
   For purposes of this invention, Ethoxylated Acetylenic Diol also plays a significant role in microcrazing remediation, which is microscopic cracks in the surface of a weathered material. The EAD modifies the surface energies allowing deep penetration of the formulation.

### Silicone Dioxide

Silicon dioxide, also known as silica or SiO2, is a naturally occurring compound. It's made of silicon and oxygen. Both elements are abundant on our planet. If you've held a rock or touched sand, you've encountered silicon dioxide. For purposes of this invention, silicone dioxide is synergistic in water repellency.

### Glycidoxypropyltrimethoxysilane

Glycidoxypropyltrimethoxysilane (GLYMO) is primarily used as a chemical intermediate and as an adhesion promoter in coatings. It is a kind of coupling agent with an epoxy group. It can be used as a sealant agent of polyurethane. It can enhance the electrical properties of epoxy-resin based sealants. It can also be used to improve the cohesiveness of sealant with water containing acrylic latex used in polyurethane and epoxy resin coatings. GLYMO can also be used as a cross-linking agent and adhesion promoter in silicone sealant products. For purposes of this invention, GLYMO is a glycidol reactive organic group and a trimethoxysilyl inorganic group that reacts organic compounds on one end and inorganic compounds on the other end of the molecule.

### 2-(2-hydroxyphenyl)-benzotriazole

2-(2-Hydroxyphenyl)-2H-benzotriazoles, also referred to as phenolic benzotriazoles, are an important class of UV absorbers comprising the benzotriazole building block. The molecules are composed of substituted benzotriazoles with a phenyl group in the 2-position, which carries a hydroxyl group in the ortho-position. For purposes of this invention, 2-(2-hydroxyphenyl)-benzotriazole functions as a UV absorber and light stabilizer.

### Diethylene Glycol Monobutyl Ether

Diethylene Glycol Monobutyl Ether is a high boiling glycol ether used in baking enamels to promote increased flow-out and leveling in paint films. It is also used in printing inks when very slow drying is desired. In textile dyeing, it promotes rapid, uniform penetration of dyes. This solvent is used as a coalescent in architectural paints, industrial latex paints, and as an organosol dispersant. The key attributes of Diethylene Glycol Monobutyl Ether are: efficient coalescent; good coupling efficiency; good solvent activity; high blush resistance; high dilution ratio; low surface tension; low volatility/low vapor pressure; miscible with water and most organic liquids; readily biodegradable; and slow evaporation rate. For purposes of this invention, Diethylene Glycol Monobutyl Ether functions as a high boiling point solvent allowing the solvency of the polyether polyurethane and allows acrylic and polyurethane polymer particles to coalesce and form a film.

### Polyether Polyurethane

The benefits of Polyether Polyurethane are as follows:
Better for higher durometer formulations
Better dynamic properties (lower hysteresis)
Better water resistance (resists hydrolyzation)
Better low temperature flexibility
Better resistance to molds and fungi
   For purposes of this invention, polyether polyurethane functions by providing elastic characteristics for the coating which allows for both penetration and a uniform surface, providing body to said formulation resisting runs and drips during application, providing pseudoplastic flow characteristics allowing it to be sprayed and applied under high shear application methods.

In one of the embodiments of the present invention, Table 1, set forth below, represents a an exterior surface rejuvenating and protecting formulation:

TABLE 1

| Active Agents: | % By Weight of Formulation |
|---|---|
| surface binding agent | from about 4 to about 40% |
| strength and elongation enhancer | from about 1 to about 70% |
| cosolvent | from about .01 to about 25% |
| corrosion inhibitor and surface active | from about .01 to about 5% |
| agent | |
| defoamer | from about .5 to about 4% |
| dynamic surface energy reducer | from about .1 to about 5% |
| water repellant | from about .1 to about 10% |
| adhesion promoter | from about .1 to about 10% |
| UV absorber and light stabilizer | from about .1 to about 15% |
| antifungal agent | from about .1 to about 30% |
| solvent | from about 2 to about 14% |
| rheology modifier | from about 2 to about 18% |

In another embodiment, Table 2, set forth below, relates to another embodiment of the formulation:

TABLE 2

| Active Agents: | % By Weight of Formulation |
|---|---|
| surface binding agent | from about 4 to about 40% |
| strength and elongation enhancer | from about 1 to about 70% |
| cosolvent | from about .01 to about 25% |
| corrosion inhibitor and surface active | from about .01 to about 5% |
| agent | |
| defoamer | from about .5 to about 4% |
| dynamic surface energy reducer | from about .1 to about 5% |
| water repellant | from about .1 to about 10% |
| adhesion promoter | from about .1 to about 10% |
| UV absorber and light stabilizer | from about .1 to about 15% |
| antifungal agent | from about .1 to about 30% |
| solvent | from about 2 to about 14% |
| rheology modifier | from about 2 to about 18% |
| Water | from about 10 to about 95% |

In still another embodiment, Table 3, set forth below, relates to another embodiment of the present invention:

TABLE 3

| Active Agents: | % By Weight of Formulation |
|---|---|
| poly methyl methacrylate | from about 4 to about 40% |
| Polyurethane | from about 1 to about 70% |
| N-methyl pyrrolidone | from about .01 to about 25% |
| Triethanolamine | from about .01 to about 5% |
| petroleum distillates | from about .5 to about 4% |
| ethoxylated acetylenic surfactant | from about .1 to about 5% |
| amorphous synthetic silica | from about .1 to about 10% |
| glycidoxypropyltrimethoxysilane | from about .1 to about 10% |
| 2-(2-hydroxyphenyl)-benzotriazole | from about .1 to about 15% |
| 3-(3,4-dichlorophenyl)-1,1-dimethylurea | from about .1 to about 30% |
| diethylene glycol monobutyl ether | from about 2 to about 14% |
| polyether polyurethane | from about 2 to about 18% |
| water | from about 10 to about 95% |

In still another embodiment, Table 4, set forth below, relates to another embodiment of the present invention:

TABLE 4

| Active Agents: | % By Weight of Formulation |
|---|---|
| acrylic methacrylate | from about 4 to about 40% |
| Polyurethane dispersion | from about 1 to about 70% |
| N-methyl pyrrolidone | from about .01 to about 25% |
| Triethanolamine | from about .01 to about 5% |
| petroleum distillate silicone | from about .5 to about 4% |
| ethoxylated acetylene | from about .1 to about 5% |
| silicone dioxide | from about .1 to about 10% |
| glycidoxypropyltrimethoxysilane | from about .1 to about 10% |
| 2-(2-hydroxyphenyl)-benzotriazole | from about .1 to about 15% |
| methyl 2-benzimidazolecarbamate | from about .1 to about 30% |
| diethylene glycol monobutyl ether | from about 2 to about 14% |
| polyether polyurethane | from about 2 to about 18% |
| water | from about 10 to about 95% |

In still another embodiment, Table 5, set forth below, relates to another embodiment of the present invention:

TABLE 5

| Active Agents: | % By Weight of Formulation |
|---|---|
| acrylic methacrylate | from about 4 to about 40% |
| Polyurethane dispersion | from about 1 to about 70% |
| N-methyl pyrrolidone | from about .01 to about 25% |
| Triethanolamine | from about .01 to about 5% |
| petroleum distillate oil | from about .5 to about 4% |
| ethoxylated acetylene | from about .1 to about 5% |
| silicone dioxide | from about .1 to about 10% |
| glycidoxypropyltrimethoxysilane | from about .1 to about 10% |
| 2-(2-hydroxyphenyl)-benzotriazole | from about .1 to about 15% |
| 3-Iodo-2-propynyl butyl carbamate | from about .1 to about 30% |
| diethylene glycol monobutyl ether | from about 2 to about 14% |
| polyether polyurethane | from about 2 to about 18% |
| water | from about 10 to about 95% |

Among those benefits and improvements that have been disclosed, other objects and advantages of this invention will become apparent from the following description taken in conjunction with the accompanying drawings. The tables and examples constitute a part of this specification and include exemplary embodiments of the present invention and illustrate various objects and features thereof.

Numerous modifications and variations of the present invention are possible in light of the above teachings. It is therefore to be understood that within the scope of the attendant claims attached hereto, this invention may be practiced otherwise than as specifically disclosed herein.

What is claimed is:

1. A formulation comprising of:
at least one surface binding agent selected from the group consisting of acrylic methacrylate, poly methyl methacrylate, styrene, styrene acrylic, styrene butadiene, vinyl acetate, vinyl acrylic, silicone, polysiloxane, silicone acrylates, polyether silicone copolymer, trimethylsiloxysilicate, silicone resin, aromatic polyurethane, polyurea, epoxy, nitrocellulose, polyvinyl butyral, cellulose acetate butyrate, chlorinated rubber, styrene butadiene styrene, epoxy polyester hybrid, urethane acrylic hybrid, urethane acrylics synthesized polymer, UV/EB Curable polymer, fluoropolymer, polyvinylidene fluoride, melamine formaldehyde, urea formaldehyde, alkyds, unsaturated polyesters, phenolic resins, polyureas, inorganic binders, silicates, drying oils, and mixture and combinations thereof;
at least one strength and elongation enhancer selected from the group consisting of polyurethane, polyvinylidene fluoride, aromatic polyurethane, melamine formaldehyde, polyurea, silicates, polyesters, styrene butadiene styrene, epoxy, nitrocellulose, styrene acrylic, vinyl acrylate, and mixture and combinations thereof;
at least one cosolvent selected from the group consisting of N-methyl pyrrolidone, propylene glycol, dipropylene glycol methyl ether, tripropylene glycol methyl ether, diethylene glycol monobutyl ether, ethyl lactate, soy methyl ester, palm oil and its derivatives, dimethyl sulfone, butyl levulinate esters, butyl levulinic esters, isobutanol, methyl soyate, 1-methylimidazole, hydrocarbon solvents, triethanolamine, methanol, benzene, acetone, ethanol, bio-based solvents, and mixtures and combinations thereof;
at least one corrosion inhibitor and surface active agent selected from the group consisting of triethanolamine, phosphate based inhibitors (zinc phosphate, calcium phosphate, strontium phosphate, etc), molybdate inhibitors such as sodium molybdate, orate based inhibitors, silicate based inhibitors such as colloidal silica, fumed silica, sodium metasilicate, organic corrosion inhibitors such as tannic acid, benzotriazole, toly triazole, 2-Mercaptobenzothiazole (MBT), amine based corrosion inhibitors such as monoethanolamine borate, diisopropanolamine derivatives, rare earth metal corrosion inhibitors such as Cerium Oxide or Cerium Nitrate, sodium benzoate, plant based corrosion inhibitors, polymeric inhibitors designed to block corrosion pathways such as polymers with functional sites or that chelate, and mixtures and combinations thereof;
at least one defoamer selected from the group consisting of petroleum distillates, petroleum distillate silicone, petroleum distillate oil, mineral oils, silicone based defoamers, polydimethylsiloxane, modified silicones, mineral oil free defoamers, fatty alcohols, esters, polymeric defoamers, polyacrylates, polyethers, siloxane copolymers, emulsion defoamers, powdered defoamers, surfactant blends, and mixture and combinations thereof;
at least one dynamic surface energy reducer selected from the group consisting of ethoxylated acetylene, silicone based modifiers such as polyether modified silicone, amino functional silicone, polydimethylsiloxanes, fluoro surfactants, fluoropolymers, polyacrylate, polyurethane surface energy modifiers, wax based surface energy modifiers, carnauba, polyethylene, polytetrafluoroethylene dispersions, silane based surface energy modifiers, nano particles hydrophobic silica, alumina, titania treated with alkyl or fluorinated compounds, and mixture and combinations thereof;
at least one water repellent selected from the group consisting of amorphous synthetic silica, silicone dioxide, wax based water repellents, fluorosurfactants and fluoropolymers, polyvinylidene fluoride, silicone based additives, siloxane emulsions, polyether modified silicone, amino functional silicone, fluoropolymers, waxes, silane, siloxane, nano particle sized additives, hydrophobically modified silica and alumina, film forming binders, hydrophobic acrylics, urethane-acrylic hybrids, silicone-acrylate copolymers, urethanes, and mixtures and combinations thereof;
at least one adhesion promoter selected from the group consisting of glycidoxypropyltrimethoxysilane, organofunctional silanes, epoxy silanes, amino silanes, methacryloxy silanes, phosphate-based adhesion promoters, zirconium phosphate, polyphosphates, anionic surfactants, cationic surfactants, functional polymers, chloropolyolefins, epoxy dispersions, polyurethane dispersions, hydroxyl polyurethane dispersions, carboxyl-modified polyurethane dispersions, maleic anhydride additives, and mixtures and combinations thereof;
at least one UV absorber and light stabilizer selected from the group consisting of hydrophilic 2-(2-hydroxyphenyl)-benzotriazole, triazines, benzotriazoles, benzophenones, hindered amine light stabilizers, titanium dioxide, zinc oxide, hybrid chemistries, photo stabilized acrylic and polyurethane polymers, fumed, amorphous, uniform or surface modified silicas, and mixtures and combinations thereof;
at least one antifungal agent selected from the group consisting of 3-(3,4-dichlorophenyl)-1,1-dimethylurea, methyl 2-benzimidazolecarbamate, 3-Iodo-2-propynyl butyl carbamate, zinc based chemistries, zinc omadine, zinc 2-pyridinethiol-N-oxide, zinc pyrithione, iodopropynyl butylcarbamate, carbamates, isothiazolinones, azole-based fungicides, organotin, quaternary ammonium compounds, metals, and mixtures and combinations thereof;
at least one solvent selected from the group consisting of diethylene glycol monobutyl ether, water, glycol ethers, alcohols, diols, polyols, esters, lactates, VOC exempt solvents, low VOC solvents, t-butyl acetate, acetone, dimethyl carbonate, methyl acetate, dibasic esters, γ-Butyrolactone, and mixtures and combinations thereof; and
at least one rheology modifier selected from the group consisting of polyether polyurethane, cellulose ethers, hydroxyethyl cellulose, hydroxypropyl methylcellulose, alkali swellable emulsions, hydrophobically modified alkali swellable emulsions, hydrophobically modified ethylene oxide urethanes, polyurethane thickeners, inorganic rheology modifiers, and mixtures and combinations thereof.

2. The formulation of claim 1 wherein said formulation designed to be applied to the exterior of commercial, residential and real estate properties such as roofs, siding and other external surfaces and said formulation functions as rejuvenating and protecting agents.

3. The formulation of claim 1 further comprises water, said water is from about 10 to about 95% by weight of said formulation.

4. The formulation of claim 1 wherein said at least one surface binding agent is from about 4 to about 40% by weight of said formulation.

5. The formulation of claim 1 wherein said at least one strength and elongation enhancer is from about 1 to about 70% by weight of said formulation.

6. The formulation of claim 1 wherein said at least one cosolvent is from about 0.01 to about 25% by weight of said formulation and

7. The formulation of claim 1 wherein said corrosion inhibitor and surface active agent is from about 0.01 to about 5% by weight of said formulation.

8. The formulation of claim 1 wherein said at least one defoamer is from about 0.5 to about 4% by weight of said formulation.

9. The formulation of claim 1 wherein said at least one dynamic surface energy reducer is from about 0.1 to about 5% by weight of said formulation.

10. The formulation of claim 1 wherein said at least one water repellant is from about 0.1 to about 10% by weight of said formulation.

11. The formulation of claim 1 wherein said at least one adhesion promoter is from about 0.1 to about 10% by weight of said formulation.

12. The formulation of claim 1 wherein said at least one UV absorber and light stabilizer is from about 0.1 to about 15% by weight of said formulation.

13. The formulation of claim 1 wherein said at least one antifungal agent is from about 0.1 to about 30% by weight of said formulation.

14. The formulation of claim 1 wherein said at least one solvent is from about 2 to about 14% by weight of said formulation.

15. The formulation of claim 1 wherein at least one rheology modifier is from about 2 to about 18% by weight of said formulation.

16. The formulation of claim 1 wherein said drying oils in said at least one surface binding agent is selected from the group consisting of tung oil, linseed oil, tall oil, dehydrated castor oil, perilla oil, soybean oil/safflower oil based alkyd resins, poppy seed oil, walnut oil and combinations and mixtures thereof.

17. A formulation comprising active agents, said active agents comprises of:
at least one liquid;
at least one surface binding agent selected from the group consisting of acrylic methacrylate, poly methyl methacrylate, styrene, styrene acrylic, styrene butadiene, vinyl acetate, vinyl acrylic, silicone, polysiloxane, silicone acrylates, polyether silicone copolymer, trimethylsiloxysilicate, silicone resin, aromatic polyurethane, polyurea, epoxy, nitrocellulose, polyvinyl butyral, cellulose acetate butyrate, chlorinated rubber, styrene butadiene styrene, epoxy polyester hybrid, urethane acrylic hybrid, urethane acrylics synthesized polymer, UV/EB Curable polymer, fluoropolymer, polyvinylidene fluoride, melamine formaldehyde, urea formaldehyde, alkyds, unsaturated polyesters, phenolic resins, polyureas, inorganic binders, silicates, drying oils, and mixture and combinations thereof;
at least one strength and elongation enhancer selected from the group consisting of polyurethane, polyvinylidene fluoride, aromatic polyurethane, melamine formaldehyde, polyurea, silicates, polyesters, styrene butadiene styrene, epoxy, nitrocellulose, styrene acrylic, vinyl acrylate, and mixture and combinations thereof;
at least one cosolvent selected from the group consisting of N-methyl pyrrolidone, propylene glycol, dipropylene glycol methyl ether, tripropylene glycol methyl ether, diethylene glycol monobutyl ether, ethyl lactate, soy methyl ester, palm oil and its derivatives, dimethyl sulfone, butyl levulinate esters, butyl levulinic esters, isobutanol, methyl soyate, 1-methylimidazole, hydrocarbon solvents, triethanolamine, methanol, benzene, acetone, ethanol, bio-based solvents, and mixtures and combinations thereof;
at least one defoamer selected from the group consisting of petroleum distillates, petroleum distillate silicone, petroleum distillate oil, mineral oils, silicone based defoamers, polydimethylsiloxane, modified silicones, mineral oil free defoamers, fatty alcohols, esters, polymeric defoamers, polyacrylates, polyethers, siloxane copolymers, emulsion defoamers, powdered defoamers, surfactant blends, and mixture and combinations thereof;
at least one UV absorber and light stabilizer selected from the group consisting of hydrophilic 2-(2-hydroxyphenyl)-benzotriazole, triazines, benzotriazoles, benzophenones, hindered amine light stabilizers, titanium dioxide, zinc oxide, hybrid chemistries, photo stabilized acrylic and polyurethane polymers, fumed, amorphous, uniform or surface modified silicas, and mixtures and combinations thereof;
at least one solvent selected from the group consisting of diethylene glycol monobutyl ether, water, glycol ethers, alcohols, diols, polyols, esters, lactates, VOC exempt solvents, low VOC solvents, t-butyl acetate, acetone, dimethyl carbonate, methyl acetate, dibasic esters, γ-Butyrolactone, and mixtures and combinations thereof; and
at least one rheology modifier selected from the group consisting of polyether polyurethane, cellulose ethers, hydroxyethyl cellulose, hydroxypropyl methylcellulose, alkali swellable emulsions, hydrophobically modified alkali swellable emulsions, hydrophobically modified ethylene oxide urethanes, polyurethane thickeners, inorganic rheology modifiers, and mixtures and combinations thereof.

18. The formulation of claim 17 wherein said formulation designed to be applied to the exterior of commercial, residential and real estate properties such as roofs, siding and other external surfaces and said formulation functions as rejuvenating and protecting agents.

19. The formulation of claim 17 wherein said liquid is selected from the group consisting of distilled water, bottled water, tap water, mineral water, purified water, alkaline water, spring water, well water, drinking water, and mixtures and combinations thereof.

20. A formulation comprising active agents, said active agents comprises of:
at least one liquid is selected from the group consisting of distilled water, bottled water, tap water, mineral water, purified water, alkaline water, spring water, well water, drinking water, and mixtures and combinations thereof;
at least one liquid is selected from the group consisting of distilled water, bottled water, tap water, mineral water, purified water, alkaline water, spring water, well water, drinking water, and mixtures and combinations thereof
at least one surface binding agent selected from the group consisting of acrylic methacrylate, poly methyl methacrylate, styrene, styrene acrylic, styrene butadiene, vinyl acetate, vinyl acrylic, silicone, polysiloxane, silicone acrylates, polyether silicone copolymer, trimethylsiloxysilicate, silicone resin, aromatic polyurethane, polyurea, epoxy, nitrocellulose, polyvinyl butyral, cellulose acetate butyrate, chlorinated rubber, styrene butadiene styrene, epoxy polyester hybrid, urethane acrylic hybrid, urethane acrylics synthesized polymer, UV/EB Curable polymer, fluoropolymer, polyvinylidene fluoride, melamine formaldehyde, urea formaldehyde, alkyds, unsaturated polyesters, phenolic resins, polyureas, inorganic binders, silicates, drying oils, and mixture and combinations thereof;
at least one strength and elongation enhancer selected from the group consisting of polyurethane, polyvinylidene fluoride, aromatic polyurethane, melamine formaldehyde, polyurea, silicates, polyesters, styrene butadiene styrene, epoxy, nitrocellulose, styrene acrylic, vinyl acrylate, and mixture and combinations thereof;
at least one cosolvent selected from the group consisting of N-methyl pyrrolidone, propylene glycol, dipropylene glycol methyl ether, tripropylene glycol methyl ether, diethylene glycol monobutyl ether, ethyl lactate, soy methyl ester, palm oil and its derivatives, dimethyl sulfone, butyl levulinate esters, butyl levulinic esters, isobutanol, methyl soyate, 1-methylimidazole, hydrocarbon solvents, triethanolamine, methanol, benzene, acetone, ethanol, bio-based solvents, and mixtures and combinations thereof;
at least one corrosion inhibitor and surface active agent selected from the group consisting of triethanolamine, phosphate based inhibitors (zinc phosphate, calcium phosphate, strontium phosphate, etc), molybdate inhibitors such as sodium molybdate, orate based inhibitors, silicate based inhibitors such as colloidal silica, fumed silica, sodium metasilicate, organic corrosion inhibitors such as tannic acid, benzotriazole, toly triazole, 2-Mercaptobenzothiazole (MBT), amine based corrosion inhibitors such as monoethanolamine borate, diisopropanolamine derivatives, rare earth metal corrosion inhibitors such as Cerium Oxide or Cerium Nitrate, sodium benzoate, plant based corrosion inhibitors, polymeric inhibitors designed to block corrosion pathways such as polymers with functional sites or that chelate, and mixtures and combinations thereof;
at least one defoamer selected from the group consisting of petroleum distillates, petroleum distillate silicone, petroleum distillate oil, mineral oils, silicone based defoamers, polydimethylsiloxane, modified silicones, mineral oil free defoamers, fatty alcohols, esters, polymeric defoamers, polyacrylates, polyethers, siloxane copolymers, emulsion defoamers, powdered defoamers, surfactant blends, and mixture and combinations thereof;
at least one dynamic surface energy reducer selected from the group consisting of ethoxylated acetylene, silicone based modifiers such as polyether modified silicone, amino functional silicone, polydimethylsiloxanes, fluoro surfactants, fluoropolymers, polyacrylate, polyurethane surface energy modifiers, wax based surface energy modifiers, carnauba, polyethylene, polytetrafluoroethylene dispersions, silane based surface energy modifiers, nano particles hydrophobic silica, alumina, titania treated with alkyl or fluorinated compounds, and mixture and combinations thereof;
at least one water repellent selected from the group consisting of amorphous synthetic silica, silicone dioxide, wax based water repellents, fluorosurfactants and fluoropolymers, polyvinylidene fluoride, silicone based additives, siloxane emulsions, polyether modified silicone, amino functional silicone, fluoropolymers, waxes, silane, siloxane, nano particle sized additives, hydrophobically modified silica and alumina, film forming binders, hydrophobic acrylics, urethane-acrylic hybrids, silicone-acrylate copolymers, urethanes, and mixtures and combinations thereof;
at least one adhesion promoter selected from the group consisting of glycidoxypropyltrimethoxysilane, organofunctional silanes, epoxy silanes, amino silanes, methacryloxy silanes, phosphate-based adhesion promoters, zirconium phosphate, polyphosphates, anionic surfactants, cationic surfactants, functional polymers, chloropolyolefins, epoxy dispersions, polyurethane dispersions, hydroxyl polyurethane dispersions, carboxyl-modified polyurethane dispersions, maleic anhydride additives, and mixtures and combinations thereof;
at least one UV absorber and light stabilizer selected from the group consisting of hydrophilic 2-(2-hydroxyphenyl)-benzotriazole, triazines, benzotriazoles, benzophenones, hindered amine light stabilizers, titanium dioxide, zinc oxide, hybrid chemistries, photo stabilized acrylic and polyurethane polymers, fumed, amorphous, uniform or surface modified silicas, and mixtures and combinations thereof;
at least one antifungal agent selected from the group consisting of 3-(3,4-dichlorophenyl)-1,1-dimethylurea, methyl 2-benzimidazolecarbamate, 3-Iodo-2-propynyl butyl carbamate, zinc based chemistries, zinc omadine, zinc 2-pyridinethiol-N-oxide, zinc pyrithione, iodopropynyl butylcarbamate, carbamates, isothiazolinones, azole-based fungicides, organotin, quaternary ammonium compounds, metals, and mixtures and combinations thereof;
at least one solvent selected from the group consisting of diethylene glycol monobutyl ether, water, glycol ethers, alcohols, diols, polyols, esters, lactates, VOC exempt solvents, low VOC solvents, t-butyl acetate, acetone, dimethyl carbonate, methyl acetate, dibasic esters, γ-Butyrolactone, and mixtures and combinations thereof; and
at least one rheology modifier selected from the group consisting of polyether polyurethane, cellulose ethers, hydroxyethyl cellulose, hydroxypropyl methylcellulose, alkali swellable emulsions, hydrophobically modified alkali swellable emulsions, hydrophobically modified ethylene oxide urethanes, polyurethane thickeners, inorganic rheology modifiers, and mixtures and combinations thereof.
